(19) United States
(12) Patent Application Publication
(10) Pub. No.: US 2004/0215528 A1
(43) Pub. Date: Oct. 28, 2004

(54) Method and apparatus for buyer created invoicing

(76) Inventors: Woon Kok Tan, Singapore (SG); Janice Seng Mui Ho, Avila Gardens Singapore (SG); Jen Leng Lam, Singapore (SG); Chin Chun Low, Singapore (SG); Young Chew Goh, Singapore (SG); John Hwan Yeow Chan, Singapore (SG)

Correspondence Address: MCDERMOTT, WILL & EMERY, 600 13th Street, N.W., Washington, DC, 20005-3096, US

(21) Appl. No.: 10/821,275

(22) Filed: Apr. 9, 2004

Related U.S. Application Data
(60) Provisional application No. 60/464,922, filed on Apr. 22, 2003.

(51) Int. Cl. G06F 17/60

(52) U.S. Cl. 705/26

(57) ABSTRACT

A method and apparatus for generating invoices at a buyer of goods or services employs a system in which the goods or services actually received are evidenced by documentation. Based upon this documentation, the buyer creates an invoice that is provided to the supplier or a third party logistics provider.

### RELATED APPLICATIONS

The present invention claims priority to provisional application 60/464,922, filed on Apr. 22, 2003, the entire disclosure of which is hereby incorporated by reference.

### FIELD OF THE INVENTION

The present invention relates generally to buying and supplying of goods or services between a buyer and a supplier, and more particularly, to invoicing systems for the goods or services supplied to a buyer.

### BACKGROUND OF THE INVENTION

During the course of business, customers need to be replenished with finished goods or partially finished goods from a manufacturer or supplier. Such finished goods may be used by the customers to form part of a product or used for other purposes. For example, a computer manufacturer may need to be supplied with many different finished goods, such as hard disk drives, motherboards, etc. Similarly, a buyer may purchase services from a supplier on a recurring basis.

It is common practice for the supplier of the goods or services to generate an invoice and send it to the buyer. The buyer then typically pays the supplier according to the invoice received. The buyer usually has in place some type of system to check that the seller-created invoice correctly reflects the quantity and price of the goods or services that were provided.

Modern manufacturing and supply arrangements have made the time-honored system of invoicing more complicated. For example, when a third party logistics (3PL) warehousing system is part of the arrangement, the amount of time and effort, including cost, required to ensure that the buyer is not paying to an incorrect invoice can be a significant burden. As one example, the supplier may place a certain number of parts in a third-party “store”. As the buyer needs the parts, such as for use in manufacturing processes, the buyer “pulls” the required number of parts out from the third-party store. In the current environment of just-in-time manufacturing and efficiency-driven manufacturing, a buyer may withdraw different types of parts in different quantities from the third-party store several times a day. On the supplier side, the supplier has to periodically count and tally the parts remaining in the third-party store in order to prepare an invoice. Discrepancies between the records of the buyer and the invoice are common. In particular, mistakes are made in counting, double entries, data entry, delayed data entries, missing data entries, etc., and human errors in such a process seem inevitable. Additionally, the process is further complicated when the buyer returns parts that had previously been drawn from the third-party store.

### SUMMARY OF THE INVENTION

There is a need for an invoicing system that is more efficient and allows fewer opportunities for human error to adversely affect the accuracy of documents generated or the payments made to a supplier.

These and other needs are met by embodiments of the present invention which provide a method of creating invoices for goods or services supplied to a buyer from a supplier. The method comprises the steps of receiving the goods or services at the buyer, the receipt of these goods or services being evidenced by a receipt document. The method further comprises the buyer generating invoices based on the receipt document and providing the generated invoices to the supplier.

The earlier stated needs are met by other aspects of the invention comprising a computer readable media bearing instructions that cause a computer at a buyer to determine at the buyer that goods have actually been received at the buyer, and create an invoice at the buyer based on the determination that goods have actually been received at the buyer.

Still further aspects of the invention satisfy the earlier stated needs and include an invoicing system for goods and services, this invoicing system comprising a computer system, and means for creating invoices from the computer system at a buyer based on goods or services actually received at the buyer.

The creation of the invoices at the buyer provides an invoicing system of improved efficiency and allows for fewer opportunities for human error to adversely affect the accuracy of the documents generated or the payments made to the supplier. Furthermore, the system reduces the tediousness of validating invoices, improving agreement between buyer and seller records, and other benefits.

The foregoing and other features, aspects and advantages of the present invention will become more apparent from the following detailed description when taken in conjunction with the accompanying drawings.

### BRIEF DESCRIPTION OF THE DRAWINGS

FIG. 1 is a basic block diagram depicting a method of invoicing in accordance with embodiments of the present invention.

FIG. 2 depicts another embodiment of the present invention.

FIG. 3 shows a still further embodiment of the present invention.

FIG. 4 depicts a more detailed flow diagram of an embodiment of the method of the present invention.

FIG. 5 depicts a system capable of performing the present invention.

### DETAILED DESCRIPTION OF THE INVENTION

The present invention addresses and solves problems related to the supplying of goods or services between a supplier and a buyer, and the invoicing for those goods or services. The present invention solves these problems, in part, by causing the receipt of goods or services at the buyer to be evidenced by a receipt document, and allowing the buyer to use this receipt document to generate invoices. These invoices are then provided to the supplier from the buyer. The use of the buyer generated invoices significantly reduces or eliminates discrepancies between the invoices and the buyers records, as the invoices are generated based on the actual goods received at the buyer.

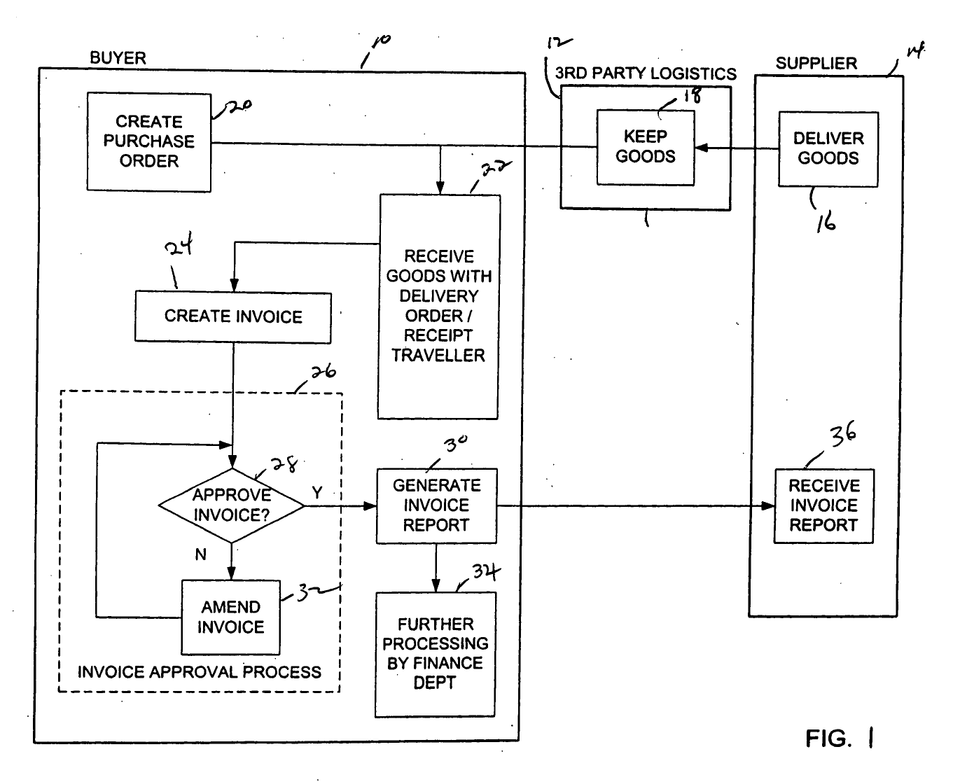

FIG. 1 is a block diagram depicting a buyer 10, a third party logistics provider 12, and a supplier 14, as well as a basic flow in accordance with embodiments of the present invention. From the following description, the example of goods being supplied and purchased by the buyer will be described. However, it should be understood that the same methodology may be applied to the purchase of services instead of goods.

In FIG. 1, the buyer 10 receives goods from a third party logistics supplier 12 that is kept supplied with goods by a supplier 14. In the normal course of business, the supplier 14 acts to deliver goods, as represented in step 16, to the third party logistics provider 12. The third party logistics provider 12 keeps the goods, as represented by step 18.

As the buyer 10 determines the needs for goods, the buyer 10 pulls the goods, as is well known in modern manufacturing. Other methods for the buyer 10 receiving goods from the third party logistics provider 12 are within the scope of the present invention.

The goods are pulled pursuant to a purchase order that has been created by the buyer 10 in step 20. Purchase orders may be created in a conventional manner, or by any method appropriate for the manufacturing facility.

Upon receipt of the goods at the buyer 10, as indicated in step 22, a delivery order or receipt traveler is received or generated. Hence, the receipt of the goods or services is evidenced by this receipt document, either the delivery order or the receipt traveler.

With the receipt of the goods evidenced by the receipt document, such as the delivery order or the receipt traveler, the buyer 10 creates an invoice as depicted in step 24. In preferred embodiments of the invention, the invoice is automatically generated in step 24 based upon the receipt document, employing a processor. Thus, the automation of the invoice creation assures accuracy, as well as conformance of the invoice to the actual goods received at the buyer 10. In other words, rather than relying on the supplier 14 to periodically count and tally the parts left in the third-party logistics store 12, and then prepare an invoice from this tally, only the actual goods received will be considered in creating the invoice at the buyer 10. This avoids the inevitable discrepancies that would otherwise occur between a buyer's records and the invoice created by the supplier 14 or the third-party logistics provider 12. These mistakes can arise from mistakes in counting, data entry, double entries, delayed data entries, missing data entry and other human errors.

Following the creation of the invoice 24, an invoice approval process 26 is entered. If the invoice is approved (Y), as indicated in step 28, an invoice report is generated at the buyer 10, as indicated in step 30. If the invoice is not approved in step 28, the invoice is amended in step 32 and then checked again to see if the invoice will be approved, in step 28.

Following the generation of the invoice report, as provided for in step 30, further processing of the invoice report may be performed by a finance department, as indicated in step 32.

Following the generation of the invoice report in step 30, the invoice report is provided to the supplier 14, who receives the invoice report in step 36. The supplier 14 can use the invoice report as needed to check against inventory, payments made by the buyer 10, etc. The invoice report may be sent to the supplier 14 from the buyer 10 through any conventional method of communication, including mail, facsimile, internet, etc. Also, a supplier 14 may be provided access to the system at the buyer 10, such as on a secured website, to review the invoice report generated in step 30. The invoice report can be generated on a periodic basis, such as weekly, or on an event-driven basis.

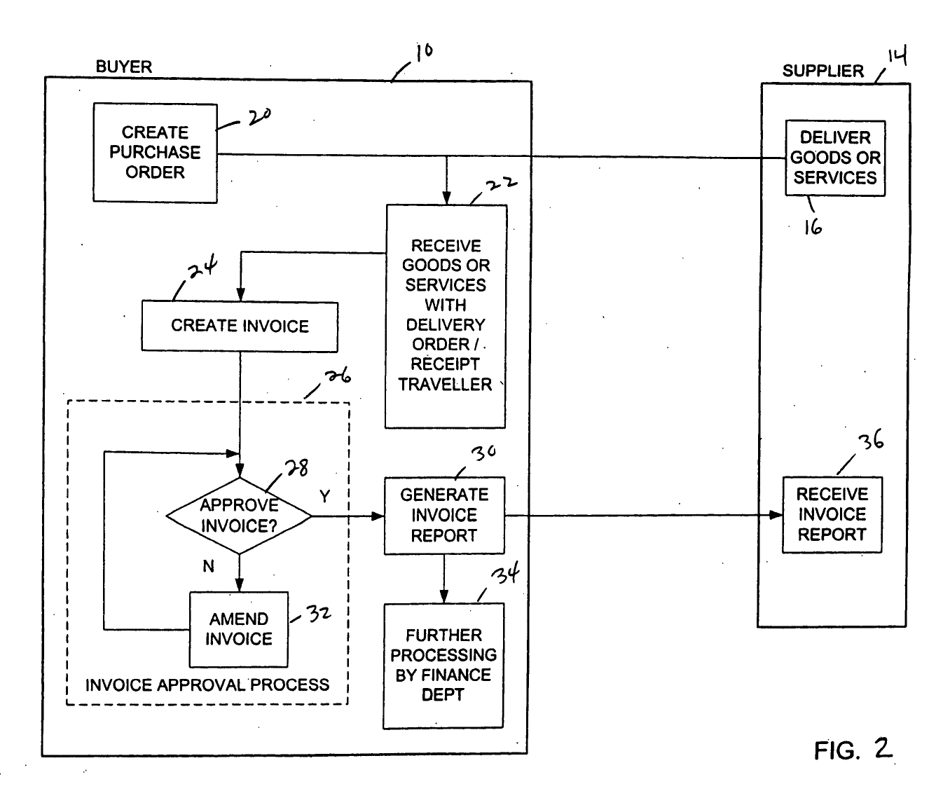

FIG. 2 depicts an embodiment in which a third-party logistics provider 12 is not interposed between the supplier 14 and the buyer 10. In other words, there is a direct supplying of goods or services from the supplier 14 to the buyer 10. In other respects, the embodiment of FIG. 2 is the same or similar to that of FIG. 1.

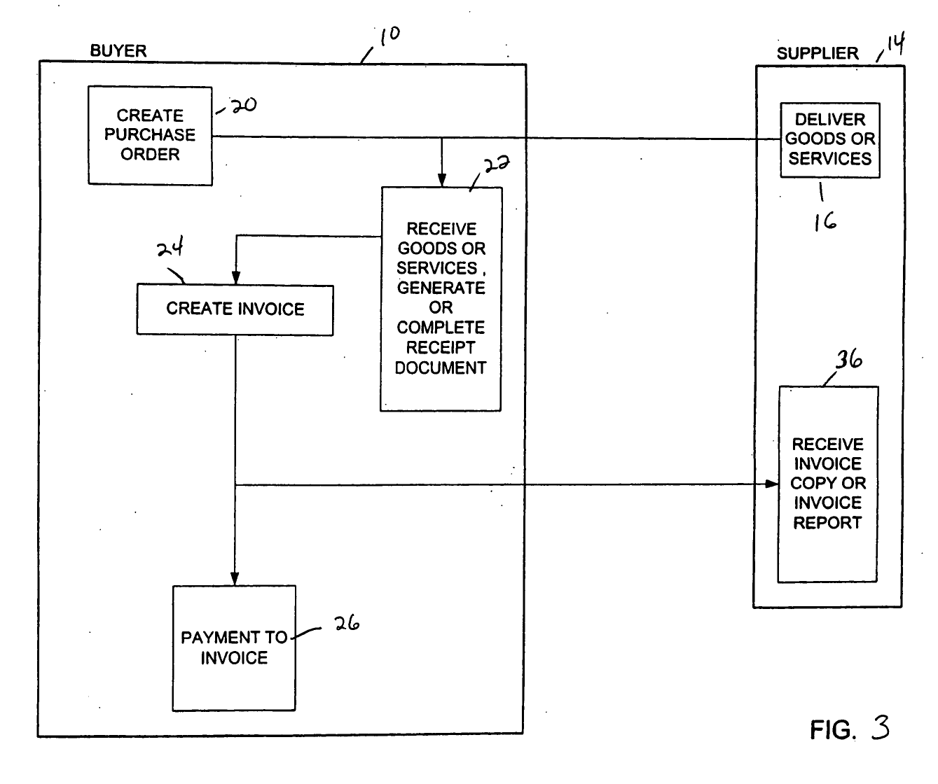

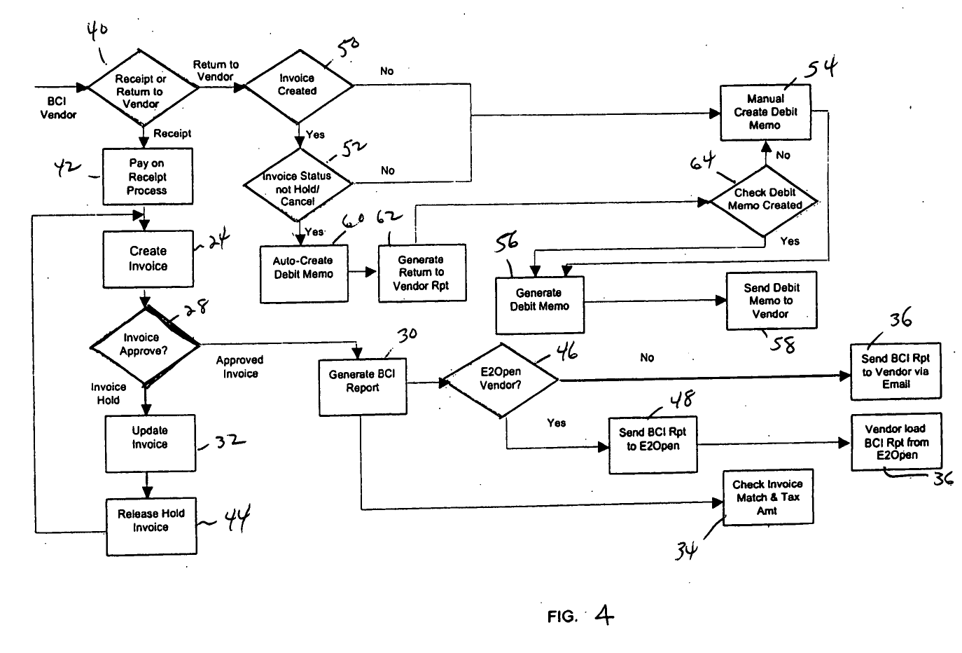

FIG. 3 is an arrangement similar to FIG. 4, but the buyer 10 does not have an invoice approval process such as that shown in FIG. 1. Certain organizations may not require a process for approving invoices, and the embodiment of FIG. 3 accommodates such organizations.

FIG. 4 is a more detailed view of a buyer created invoice process in accordance with the present invention. From materials delivered to the buyer's receiving store, a buyer's store clerk may count the physical quantity of goods or services delivered and agrees to a delivery order, and acknowledges the receipt of the goods or services by stamping and signing the delivery order, for example. The buyer's store clerk performs a receiving transaction and generates a receipt traveler based on the information in the delivery order.

In step 40, it is determined whether goods have been received or returned to the vendor. If goods have been received, a pay-on-receipt process is entered in step 42. Otherwise, a return to vendor process is started. The pay-on-receipt process is such as that shown in FIGS. 1-3. An invoice is created employing the same step as described in FIGS. 1-3, in step 24. It is then determined in step 28 whether the invoice is approved. If the invoice is not approved (“invoice hold”), the invoice may be amended or updated, as in step 32. Following the updating of the invoice in step 32, the hold on the invoice is released in step 44.

Assuming that the invoice is approved, as determined in step 28, a buyer generated invoice (or buyer created invoice) report is generated in step 30. If the vendor or supplier 14 is allowed to access the buyer's website, as determined in step 46, a buyer created invoice report is sent to the website in step 48. The vendor is then able to load the buyer created invoice report in step 36. If, however, the vendor is not allowed to, or is unable to, access the buyer created invoice report from the buyer's website, the vendor is sent the buyer created invoice report via e-mail or other methods, as depicted in FIG. 4.

In addition to providing the supplier 14 with the buyer created invoice report, the invoice report is also sent to the finance department of the buyer 10 for further processing. This includes step 34, that involves checking the matching of the invoices and the tax amounts, etc.

The present invention accounts for returns of parts and goods to a supplier 14, as determined in step 40. In step 50, it is determined whether an invoice has already been created. If such an invoice has already been created by the buyer 10, it is determined in step 52 whether any invoice is on hold status and that no invoice is on cancel status. If no invoice is on hold or on cancel status, or if no invoice has already been created, as determined in steps 50 and 52, a manual debit memo is created in step 54. From there, a debit memo is generated by the buyer 10 in step 56 and is sent to the vendor or supplier 14 in step 58.

However, if an invoice has already been created, and there is no invoice that is on hold status or on cancel status, a debit memo is automatically created by the method of the present invention in step 60. This generates a return to supplier or vendor report 62. In step 64, a check is made as to whether a debit memo has been created. If yes, the debit memo is generated in step 56 as previously described. If a debit memo has not been created, as determined in step 64, a debit memo is manually created, as previously described with respect to step 54.

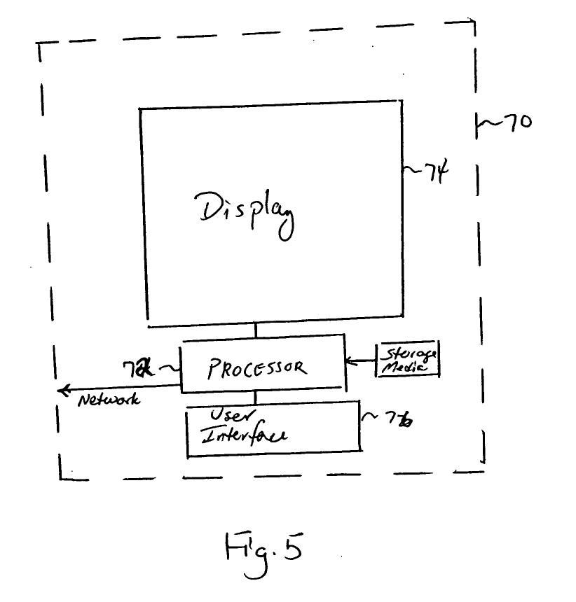

FIG. 5 depicts a system 70 capable of performing the functionality of the methodology described with respect to FIGS. 1-4. The system 70 includes a processor 72, a display 74, and a user interface 76. As is conventionally known, the processing system 70 is able to communicate via a network, either wirelessly or wired. The processing system 70 is configured to perform the methodologies described with respect to FIGS. 1-4 by software stored on a computer readable medium.

The present invention thus provides a method of creating a buyer generated or buyer created invoice following the receipt of goods by a buyer from a supplier, or a third-party logistics provider. Since the buyer created invoice is based on the receipt document and/or documents, such as purchase orders, delivery orders, etc., the buyer created invoice will be particularly accurate and reflect the actual goods or services received. Discrepancies between a buyer's records and the invoices are significantly reduced, if not eradicated. Further, time delays between the supplier's tallying of remaining goods and the buyer's frequent withdrawal of the goods is reduced as a problem.

Although the present invention has been described and illustrated in detail, it is to be clearly understood that the same is by way of illustration and example only and is not to be taken by way of limitation, the scope of the present invention being limited only by the terms of the appended claims.

What is claimed is:

1. A method of creating invoices for goods or services supplied to a buyer from a supplier, comprising the steps:
receiving the goods or services at the buyer, the receipt of the goods or services evidenced by a receipt document; and
the buyer generating invoices based on the receipt document and providing the generated invoices to the supplier.

2. The method of claim 1, wherein the receipt document reflects actual goods or services received at the buyer.

3. The method of claim 2, wherein the buyer pulls the goods or services from the supplier.

4. The method of claim 2, wherein a third party logistics warehouse system is interposed between the supplier and the buyer, such that the third party logistics warehouse system receives the goods or services from the supplier and makes the goods or services available to the buyer.

5. The method of claim 4, wherein the buyer pulls the goods or services from the third party logistics warehouse system.

6. The method of claim 2, further comprising checking the generated invoices and determining whether the generated invoices are approved prior to providing the generated invoices to the supplier.

7. The method of claim 2, further comprising the buyer generating reports based on the generated invoices, the reports containing logistical data.

8. The method of claim 2, further comprising a plurality of suppliers that supply the goods or services to the buyer, the plurality of suppliers being identifiable by the buyer such that a particular supplier supplying particular goods or services is identified by the buyer upon receipt of the goods or services.

9. The method of claim 2, further comprising determining whether goods are returned to the supplier, and generating a debit memo if goods have been returned to the supplier.

10. A computer readable media bearing instructions that cause a computer at a buyer to:
determine at the buyer that goods have actually been received at the buyer; and
create an invoice at the buyer based on the determination that goods have actually been received at the buyer.

11. The media of claim 10, wherein the instructions further cause the computer to generate an invoice report and forward the invoice report to a vendor.

12. The media of claim 11, wherein the determination at the buyer that goods have actually been received includes inputting a receipt traveler upon verification of goods received at the buyer.

13. The media of claim 12, wherein the instructions further cause the computer to create a purchase order for goods.

14. The media of claim 13, wherein the instructions further cause the computer to forward the invoice to an invoice approval process prior to generating an invoice report.

15. The media of claim 14, wherein the instructions further cause the computer to generate a debit memo when goods are returned to a vendor.

16. The media of claim 15, wherein the instructions further cause the computer to forward the invoice report to the vendor by electronic mail.

17. An invoicing system for goods and services, comprising:
a computer system; and
means for creating invoices from the computer system at a buyer based on goods or services actually received at the buyer.

18. The system of claim 17, wherein the means for creating invoices includes means for creating the invoices based on receipt documents that document the actual receipt of the goods or services at the buyer.

19. The system of claim 18, further comprising means for providing an invoice report to a vendor based on the invoices created at the buyer.

20. The system of claim 19, further comprising means for generating a debit memo to the vendor when goods are returned to the vendor.
